(19) United States
(12) Patent Application Publication
(10) Pub. No.: US 2013/0227011 A1
(43) Pub. Date: Aug. 29, 2013

(54) Interest-Based Social Recommendations for Event Ticket Network Systems

(71) Applicants: Vipul Sharma, San Jose, CA (US); Eyal Reuveni, San Francisco, CA (US); Brian Richard Zambrano, San Francisco, CA (US); Luke O'Daniel Groesbeck, San Francisco, CA (US)

(72) Inventors: Vipul Sharma, San Jose, CA (US); Eyal Reuveni, San Francisco, CA (US); Brian Richard Zambrano, San Francisco, CA (US); Luke O'Daniel Groesbeck, San Francisco, CA (US)

(73) Assignee: Eventbrite, Inc., San Francisco, CA (US)

(21) Appl. No.: 13/408,776

(22) Filed: Feb. 29, 2012

(51) Int. Cl. G06F 15/16

(52) U.S. Cl. 709/204

(57) ABSTRACT

In one embodiment, a method includes accessing a graph structure comprising a plurality of nodes and edges connecting the nodes, determining a similarity score for each node with respect to a first node, ranking each of the nodes based on their respective similarity score, selecting a set of nodes based on the ranking of each node, and identifying one or more event associated with the selected set of nodes.

### TECHNICAL FIELD

This disclosure generally relates to online event management systems and recommendation systems.

### BACKGROUND

Many websites allow users to conduct a variety of actions online, such as viewing content, writing reviews, ordering items, purchasing tickets, etc. These websites often present the user with a plurality of actions to choose from and allow the user to select the type of action he would like to perform. Once the action is selected, the website typically redirects the client system of the user to a webpage where the action can be completed. For example, some websites allow users to organize events using an online event management system. An online event management system may allow an event organizer to organize and manage various aspects of an event, such as, for example, managing attendee registrations and selling tickets, promoting the event, and managing attendee check-in at the event. An online event management system may also allow users to view event profiles, register for events, and purchase tickets for events. A social-networking system, such as a social-networking website, may enable its users to interact with it and with each other through the system.

Internet users may maintain one or more accounts with various service providers, including, for example, online social-networking systems and online event management systems. Online systems can typically be accessed using suitable browser clients (e.g., MOZILLA FIREFOX, GOOGLE CHROME, MICROSOFT INTERNET EXPLORER).

### BRIEF DESCRIPTION OF THE DRAWINGS

FIG. 1 illustrates an example system for implementing an online event management system.

FIGS. 2A and 2B illustrate example graph structures.

FIG. 3 illustrates an example method for recommending events based on user similarity.

FIG. 4 illustrates an example computer system.

FIG. 5 illustrates an example network environment.

### DESCRIPTION OF EXAMPLE EMBODIMENTS

### System Overview

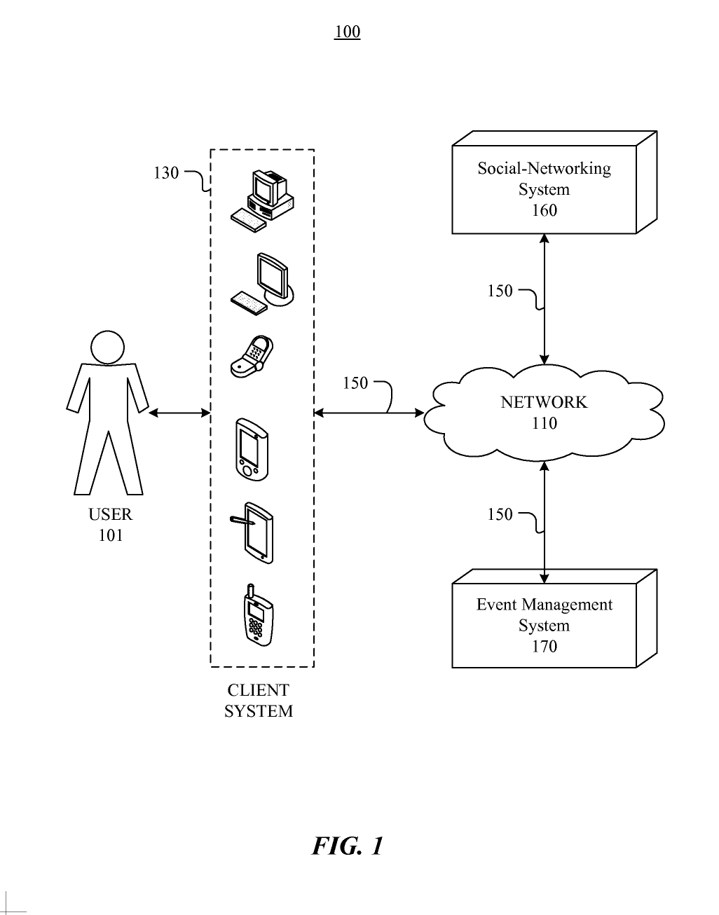

FIG. 1 illustrates an example system 100 for implementing an online event management system. System 100 includes a user 101, a client system 130, a social-networking system 160, and an event management system 170 connected to each other by a network 110. Although FIG. 1 illustrates a particular arrangement of user 101, client system 130, social-networking system 160, event management system 170, and network 110, this disclosure contemplates any suitable arrangement of user 101, client system 130, social-networking system 160, event management system 170, and network 110. As an example and not by way of limitation, two or more of client system 130, social-networking system 160, and event management system 170 may be connected to each other directly, bypassing network 110. As another example and not by way of limitation, two or more of client system 130, social-networking system 160, and event management system 170 may be physically or logically co-located with each other in whole or in part. As yet another example, one or more social-networking systems 160 may be physically or logically co-located with one or more event management systems 170 in whole or in part. Moreover, although FIG. 1 illustrates a particular number of users 101, client system 130, social-networking systems 160, event management systems 170, and networks 110, this disclosure contemplates any suitable number of users 101, client systems 130, social-networking systems 160, event management systems 170, and networks 110. As an example and not by way of limitation, system 100 may include multiple users 101, client systems 130, social-networking systems 160, event management systems 170, and networks 110.

In particular embodiments, an event management system 170 may be a network-addressable computing system that can host one or more event organization and management systems. An event management system 170 may generate, store, receive, and transmit event-related data, such as, for example, event profiles, event details, event history details, event registration details, event organizer details, event attendee details, ticket purchase details, and event displays. An event management system 170 may be accessed by the other components of system 100 either directly or via network 110. In particular embodiments, social-networking system 160 may be a network-addressable computing system that can host one or more social graphs. Social-networking system 160 may generate, store, receive, and transmit social-networking data, such as, for example, user profile data, social graph data, friend connection details, user inputs, and social-network displays. The social-networking system 160 may create and store a record, often referred to as a user profile, in connection with a user 101. The user profile may include a user 101's demographic information, communication channel information, and personal interests. The social-networking system 160 may also create and store a record of a user 101's relationship with other users 101 in the social-networking system 160 (e.g., a social graph), as well as provide services (e.g., wall-posts, photo-sharing, event organization, messaging, games, or advertisements) to facilitate social interaction between users 101 in the social-networking system. The social-networking system 160 may transmit contents and messages related to its services to a user 101's client system 130 over a network 110. Social-networking system 160 may be accessed by the other components of system 100 either directly or via network 110. Social-networking system 160 may be an independent system or a subsystem of event management system 170. Social-networking system 160 may be a third-party social-networking service, such as, for example, FACEBOOK, LINKEDIN, TWITTER, GOOGLE+, MYSPACE, another suitable third-party social-networking service, or any combination thereof.

In particular embodiments, one or more users 101 may use one or more client systems 130 to access, send data to, and receive data from an event management system 170 or a social-networking system 160. A client system 130 may access an event management system 170 or a social-networking system 160 directly, via network 110, or via a third-party system. A client system 130 may be any suitable computing device, such as, for example, a personal computer, a laptop, a cellular phone, a smart phone, or a computing tablet. In particular embodiments, one or more users 101 may be an automated system, such as, for example, a computer program, an internet bot, another type of automated system, or two or more such systems.

Network 110 may be any suitable communications network. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Connections 150 may connect client system 130, social-networking system 160, and event management system 170 to communication network 110 or to each other. This disclosure contemplates any suitable connections 150. In particular embodiments, one or more connections 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 150 each include an ad hoc network, an intranet, an extranet, a VPN, a LAN, a WLAN, a WAN, a WWAN, a MAN, a portion of the Internet, a portion of the PSTN, a cellular telephone network, another connection 150, or a combination of two or more such connections 150. Connections 150 need not necessarily be the same throughout system 100. One or more first connections 150 may differ in one or more respects from one or more second connections 150.

### Event Management Systems

In particular embodiments, an event management system 170 may allow users to create, organize and manage events. An event may be, for example, a party, a concert, a conference, a sporting event, a fundraiser, a networking event, an art event, or a live performance. Events may occur online (such as, for example, a web-based seminar) and offline (such as, for example, a live seminar in a lecture hall). An event management system 170 may allow an event organizer to organize and manage various aspects of an event, such as, for example, creating event profiles, managing attendee registrations and selling tickets, managing funds from ticket sales, promoting the event, and managing attendee check-in at the event. An event management system 170 may also allow event attendees to view and manage various aspects of registering for an event, such as, for example, viewing event profiles, viewing event history information, registering for events, and purchasing tickets for events. As an example and not by way of limitation, a first user may use event management system 170 to create and organize an event. The first user may create an event profile for the event and input event information/parameters associated with the event. As used herein, the terms “event information” and “event parameter” may be used interchangeably to refer to data in an event profile describing one or more aspects of an event. The event profile may be viewable in one or more webpages or other content served by event management system 170. One or more second users may then use event management system 170 to register for the event. The second users may view an event profile associated with the event and then register or purchase tickets for the event. Although this disclosure describes particular types of events, this disclosure contemplates any suitable types of events. Moreover, although this disclosure describes organizing and managing particular aspects of an event, this disclosure contemplates organizing and managing any suitable aspects of an event. Furthermore, although this disclosure uses the term “ticket,” this disclosure is applicable to events that do not use physical tickets and even ticketless events where attendees merely register for the event. Thus, unless context suggests otherwise, the term “ticket” (whether alone or when used in conjunction with other terms) may be considered synonymous with “registration.”

In particular embodiments, an event management system 170 may have an event profile associated with each event managed by the system. An event profile may be accessed and displayed by any suitable client system 130. An event profile may include event information describing the event title, the event date/time, the event category or type, the event details, the description of the event, the event cost or ticket price for the event, the event organizer, the event promoter, the geographic location of the event, the venue for the event, a venue capacity, the performer for the event, the number of tickets available for the event, the type/class of tickets available for the event, the ticket identifiers, the event attendees, the attendee check-in status of each event attendee, the ticket-selling window (a start time and an end time during which tickets can be sold), friends/connections of the user 101 who are attending the event, references to additional information (such as, for example, hypertext links to resources related to or describing the event, and the like), privacy settings for the event profile, or other suitable event information. Although this disclosure describes particular types of event information, this disclosure contemplates any suitable types of event information.

In particular embodiments, the event profile may include an event attendee list. The event attendee list may include, for example, information describing the attendees registered to attend the event, include the attendee's name, phone number, mailing address, email address, payment information, ticket order information, ticket information, check-in status, and other suitable attendee information. Each attendee may be assigned one or more tickets, and each ticket may have a unique ticket identifier. A ticket identifier may be an identification number, a barcode, a 2D barcode, a QR code, or another suitable unique identifier. Although this disclosure describes particular types of information associated with an event attendee list, this disclosure contemplates any suitable types of information associated with an event attendee list.

In particular embodiments, the event profile may include a total number and type of tickets that are available for the event. The type of tickets available for an event may include, for example, premium tickets, general admission tickets, reserved seating tickets, another suitable type of tickets, or two or more such types of tickets. There may be various numbers of each ticket type available for the event. The number of tickets available for an event may be based on a variety of factors. As an example and not by way of limitation, the event organizer or venue owner may specify a particular number of tickets that may be sold for the event. As another example and not by way of limitations, the number of tickets that may be sold may be based on the size or capacity of the venue. Although this disclosure describes particular numbers and types of tickets that are available for an event, this disclosure contemplates any suitable numbers and types of tickets that are available for an event.

In particular embodiments, a client system 130 may access purchase information corresponding to an order. A purchase information may include, for example, an attendee's name, phone number, mailing address, email address, billing address, payment information, ticket order information, or other suitable purchase information. Payment information may include, for example, credit card information, bank account number, PAYPAL username, cash payment information, money transfer information, address verification system score for the payment, validity information for the payment, or other suitable payment information. Although this disclosure describes particular types of purchase information and payment information, this disclosure contemplates any suitable types of purchase information and payment information.

In particular embodiments, each user 101 of event management system 170 may have an event history information associated with the user 101. Event history information may include event information and payment information associated with one or more events a user 101 has attended or has registered to attend, as well as purchase history information associated with each event. Event history information may also include event information associated with one or more event profiles a user 101 has created, organized, and managed. Although this disclosure describes particular event history information, this disclosure contemplates any suitable event history information.

In particular embodiments, the event management system 170 may use a unique client identifier (ID) to identify a user 101. As an example and not by way of limitation, the event management system 170 may assign a unique client identifier to each client system 130. The event management system 170 may assign each client system 130 with an unique client identifier based on the IP address of the client system 130, tracking cookies on the client system 130 (which may be appended to HTTP requests transmitted by the client system 130), the serial number or asset tag of the client system 130, or other suitable identifying information. As another example and not by way of limitation, the event management system 170 may assign a unique client identifier to each user 101, which the user may provide to the event management system 170 via a client system 130. The event management system 170 may assign each user 101 with a username and password that the user 101 can input into client system 130, which then transmits the username and password to the event management system 170. In particular embodiments, the event management system 170 can use the unique client identifier to determine that the user 101 is accessing the system. As yet another example and not by way of limitation, the event management system 170 may assign a unique client identifier to each attendee of an event. Although this disclosure describes using client identifiers in a particular manner, this disclosure contemplates using client identifiers in any suitable manner.

In particular embodiments, the event management system 170 may maintain an event management account for a user 101. The event management account may contain a variety of information about the user 101. As an example and not by way of limitation, an event management account may contain personal information (such as, for example, name, sex, location, interests), social-network information (such as, for example, friend connections, personal information about user 101's friends), financial information (such as, for example, income, credit history), event history information (such as, for example, the type, data, cost, venue, performers, geographic location of the events a user 101 has organized, registered for, or attended), or other suitable information related to the user 101. Although this disclosure describes event management accounts containing particular types of information about a user 101, this disclosure contemplates event management accounts containing any suitable information about a user 101.

In particular embodiments, an event management system 170 may use a “shopping cart” model to facilitate event registration. As an example and not by way of limitation, the event management system 170 may present a user 101 with a plurality of event profiles. The user 101 may select one or more of the events to register for. When the user 101 selects an event profile on the event management system 170, the event management system 170 may metaphorically add that item (e.g., registration for the event) to a shopping cart. If appropriate, the user 101 may also select a ticket type or a number of tickets for the event. When the user 101 is done selecting event profiles, then all the items in the shopping cart may be “checked out” (i.e., ordered) when the user 101 provides payment information (and possibly shipment information). In particular embodiments, when a user 101 selects an event profile, then that event profile may be “checked out” by automatically prompting the user for purchase information, such as, for example, the user's name and payment information. The user 101 then may be presented with a registration webpage that prompts the user for the user-specific registration information to complete the registration. That webpage may be pre-filled with information that was provided by the user 101 when registering for another event or when establishing an event management account on the event management system 170. The information may then be validated by the event management system 170, and the registration may be completed. At this point, the user 101 may be presented with a registration confirmation webpage or a receipt that displays the details of the event and registration details. The event management system 170 may also charge or withdraw funds from a financial account associated with the user 101 based on the payment information provided by the user 101. The “shopping cart” model may be facilitated by a client system 130 operating offline from the event management system 170. Although this disclosure describes particular means for registering for events and purchasing tickets, this disclosure contemplates any suitable means for registering for events and purchasing tickets.

### Graph Structures and Social Graphs

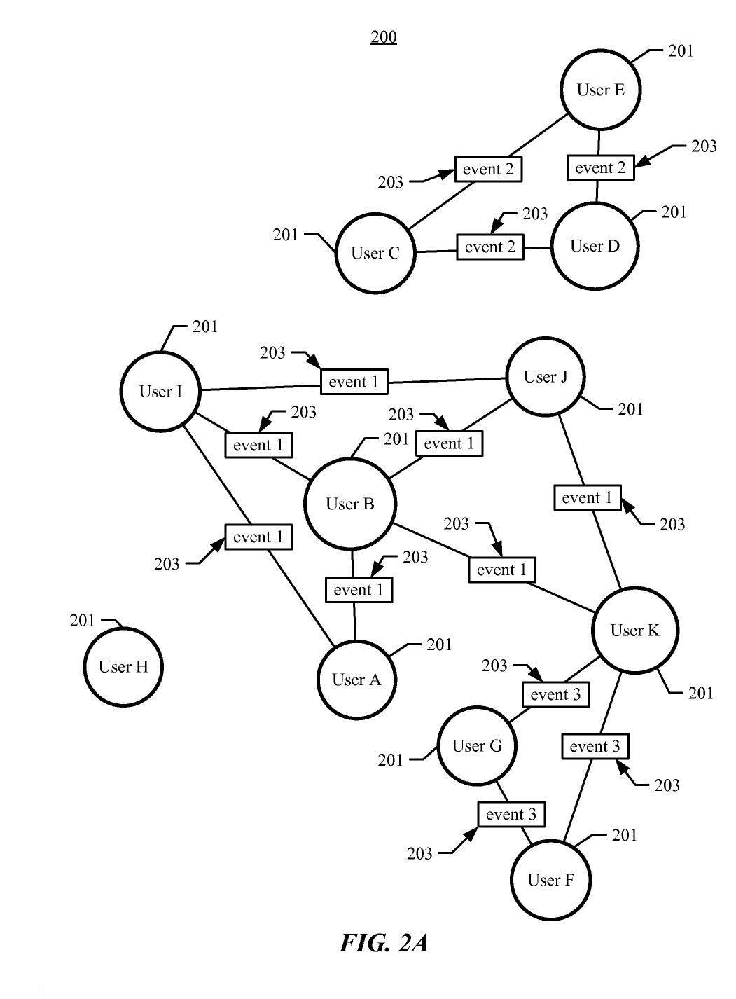

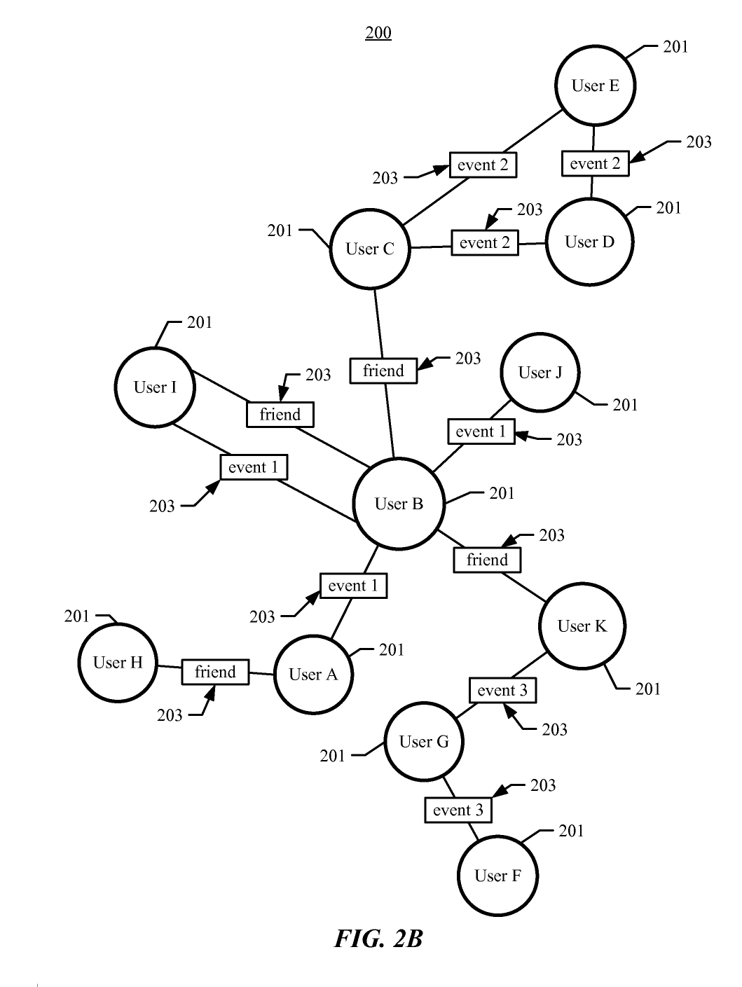

FIGS. 2A and 2B illustrate example graph structures 200. In particular embodiments, a social-networking system 160 or an event management system 170 may store records of users and relationships between users in one or more graph structures. Graph structure 200 includes a plurality of user nodes 201 and a plurality of edges 203 connecting the nodes. Although FIGS. 2A and 2B illustrates a particular arrangement of user nodes 201 and edges 203, this disclosure contemplates any suitable arrangement of user nodes 201 and edges 203. Moreover, although FIGS. 2A and 2B illustrates a particular number of user nodes 201 and edges 203, this disclosure contemplates any suitable number of user nodes 201 and edges 203.

In particular embodiments, one or more components of system 100 may store a graph structure 200. A graph structure host may be a network-addressable system that hosts and manages one or more graph structures, wherein each graph structure may represent a plurality of users 101, and wherein each user 101 may be associated with one or more graph structures. As an example and not by way of limitation, a graph structure may be a social graph hosted and managed by a social-networking system 160 (e.g., FACEBOOK, GOOGLE+, TWITTER, LINKEDIN, MYSPACE). As another example and not by way of limitation, a graph structure may be hosted and managed by the event management system 170. As yet another example and not by way of limitation, social-networking system 160 may host and manage one or more first graph structures 200 and event management system 170 may host and manage one or more second graph structures 200. Although this disclosure describes particular graph structures, this disclosure contemplates any suitable graph structures.

In particular embodiments, each user node 201 in graph structure 200 may correspond to a user 101 of a social-networking system 160 or an event management system 170. As an example and not by way of limitation, when a user registers for an account with the event management system 170, the event management system 170 may create a user node 201 corresponding to the user, and store the user node 201 in one or more data stores 101. In particular embodiments, the user node 201 may be associated with user information provided by the user and information gathered by various systems, such as, for example, information gathered by the social-networking system 160, the event management system 170, a third-party system, another suitable system, or any combination thereof. As an example and not by way of limitation, the user may provide his name, profile picture, contact information, birth date, gender, marital status, family status, employment, education background, preferences, interests, or other demographical information to be associated with the user node 201. In particular embodiments, each user node 201 may comprise one or more data objects corresponding to information associated with a user. Although this disclosure describes particular user nodes corresponding to particular graph structures of particular systems, this disclosure contemplates any suitable user nodes corresponding to any suitable graph structures of any suitable systems.

In particular embodiments, an edge 203 connecting a pair of nodes may represent a relationship between the pair of nodes. An edge 203 in a graph structure 200 may be formed explicitly or implicitly. In particular embodiments, an edge 203 may represent an event relationship. FIG. 2A illustrates an example graph structure where user nodes 201 are connected by edges 203 that represent event relationships. An edge connecting two nodes 201 in a graph structure 200 may represent, for example, that the users corresponding to the two nodes 201 have attended the same event, are registered for the same event, have recommended the same event, have been recommended the same event, another suitable relationship, or any combination thereof. Additionally, an edge connecting a first and second node in a graph structure 200 may represent, for example, that a first user corresponding to the first node has performed one of the following actions with respect to a second user corresponding to the second node: invited the user to an event, recommended an event to the user, purchased a ticket for the event for the user, registered the user for an event, another suitable action, or any combination thereof. As an example and not by way of limitation, as illustrated in FIG. 2A, User B has attended Event 1 with Users A, I, J, and K. Note that some edges 203 are not illustrated in FIG. 2A for purposes of clarity, such as an edge 203 connecting Users A and J, or Users A and K, where both Users J and K attended Event 1 with User A. As another example and not by way of limitation, as illustrated in FIG. 2A, Users C, D, and E all attended Event 2, while Users F, G, and K all attended Event 3 together. As yet another example and not by way of limitation, as illustrated in FIG. 2A, User H did not attend any of Events 1, 2 or 3, and thus is not connected to any other users in the graph structure 200. In particular embodiments, an edge 203 may represent a social relationship. FIG. 2B illustrates an example graph structure where user nodes 201 are connected by edges 203 that represent both event relationship and social relationships. An edge connecting two nodes 201 in a graph structure 200 may represent, for example, a friendship, a family relationship, a business relationship, a fan relationship, a follower relationship, a visitor relationship, a subscriber relationship, a superior/subordinate relationship, a group relationship, a union relationship, a partnership relationship, another suitable type of relationship, or any combination thereof. As an example and not by way of limitation, as illustrated in FIG. 2B, User B has a “friend” relationship with Users C, I, and K. As another example and not by way of limitation, User A has a “friend” relationship with User H. Note that some edges 203 are not illustrated in FIG. 2B for purposes of clarity, such as an edge 203 connecting Users A and I, or Users A and J, where both Users I and J attended Event 1 with User A. In particular embodiments, an edge 203 may represent a relationship with an intensity, degree, or direction. As an example and not by way of limitation, an edge connecting two nodes 201 in a graph structure my represent a reciprocal relationship, a non-reciprocal relationship, a unilateral relationship, a bilateral relationship, an weak relationship, a strong relationship, an explicit relationship, an implied relationship, another suitable relationship, or any combination thereof. Although this disclosure describes and FIGS. 2A and 2B illustrates edges with particular attributes connecting user nodes, this disclosure contemplates edges with any suitable attributes connecting user nodes. Moreover, although this disclosure describes particular users as having a relationship within a graph structure for the purposes of this disclosure, the particular users may or may not have a relationship in real life (i.e., in disintermediated interactions or the like).

In particular embodiments, an event management system 170 may host and manage a first graph structure and may also access a social-networking system 160 that hosts and manages a second graph structure. A particular user 101 may be a user of both the event management system 170 and the social-networking system 160, and may correspond to a user node 201 in the graph structures hosted and managed by each system, respectively. As an example and not by way of limitation, a user 101 may correspond to a first user node in a first graph structure on event management system 170, and may correspond to a second user node in a the second graph structure on social-networking system 160. In particular embodiments, the graph structure hosted and managed by the event management system 170 may be related to or based on the graph structure hosted and managed by the social-networking system 160. The graph structure on the event management system 170 may be a subset, superset, or independent of the graph structure on the social-networking system 160. As an example and not by way of limitation, the graph structure of the event management system 170 may comprise nodes based on the users 101 of the event management system, edges based on their event relationships (e.g., attending the same event), and edged based on the social relationships (e.g., friend connections) on the graph structure of the social-networking system 160.

In particular embodiments, each edge 203 may comprise one or more data objects or attributes corresponding to the relationship between a pair of nodes. As an example and not by way of limitation, a first user may indicate that a second user is a “friend” of the first user. In response to this indication, the event management system 170 may transmit a “friend request” to the second user. If the second user confirms the “friend request,” the event management system 170 may create an edge connecting the first user and the second user in graph structure 200, and store the edge in one or more of data stores 101. In the example of FIG. 2B, graph structure 200 includes an edge indicating a friend relation between user nodes of User A and User H, and an edge indicating an event relationship between user nodes of User A and User B.

The minimum number of edges required to connect a first node to second node on a graph structure is considered the degree of separation between the nodes (and thus, the degree of separation between the users corresponding to those nodes). If a first node and a second node are directly connected by a single edge, they are deemed to be separated by one degree of separation. The second user would be a so-called “first-degree relation” of the first user. As an example and not by way of limitation, as illustrated in FIG. 2B, User B and User K are connected by a single edge, and thus User B and User K are first-degree relations. If a first node and a second node are connected by two edges via an intermediate node, they are deemed to be separated by two degrees of separation. The second user would now be a so-called “second-degree relation” of the first user. As an example and not by way of limitation, as illustrated in FIG. 2B, User C and User K are connected by two edges via intermediate user B, and thus User C and User K are second-degree relations. Where the first user and second user are connected through N edges (or N−1 other users), they are deemed to be separated by N degrees of separation. The second user would now be a so-called “Nth-degree relation.” As used herein, when two nodes are referred to as being “connected,” it means they are connected by a single edge, unless context suggests otherwise.

In particular embodiments, an edge 203 may be formed explicitly (e.g., users actively indicate that there is a connection between them) when a first user and a second user indicate to a graph structure host (such as, for example, social networking system 160 or event management system 170) that the system should establish an edge between their nodes in the graph structure 200. As an example and not by way of limitation, User A may access a webpage on a social-networking system 160 associated with User H's social-network account and click “Add as Friend” to establish a connection. The social-networking system 160 may then require User H to accept or verify the friend request. If User H accepts the friend request, the social-networking system 160 may create an edge 203 between the user nodes 201 corresponding to Users A and H on the graph structure 200.

In particular embodiments, an edge 203 may be formed implicitly (e.g., system observes user behaviors and creates connections between users as appropriate) when a graph structure host determines that a relationship exists between two users. A graph structure host may analyze social-network information, event history information, and other suitable information to infer connections. In particular embodiments, the event management system 170 may analyze social-network information for one or more users 101 and infer connections therefrom. Social-network information may include a user 101's name, sex, race/ethnicity, geographic location, interests, employment history, education, schedule, relationships, groups, friend connections, similarity scores, social graph usage history, and other suitable social-network information. As an example and not by way of limitation, if User B and User K are “friends” on a social-networking system 160 (e.g., FACEBOOK), the event management system 170 may presume a connection between them and create an edge 203 in the graph structure 200 on the event management system 170. As another example and not by way of limitation, the event management system 170 may form connections programmatically based a user 101's personal information (e.g., connections may be implied between all users in the same geographic area, in the same company, or in the same school). Social-network information may be accessed from a social-networking system 160, an event management system 170, another suitable system, or any combination thereof. As an example and not by way of limitation, an event management system 170 may also store information regarding a user's name, sex, race/ethnicity, geographic location, etc. In particular embodiments, the event management system 170 may analyze event history information for one or more users 101 and infer connections therefrom. As example and not by way of limitation, event management system 170 may analyze event history information for User B and infer edges connections based on this information. The event management system 170 may access User C's event history information, which may identify one or more events User C has attended or has registered to attend, as well as the number, type, geographic location, venue, performer, other users in attendance at the event, and other suitable event information. For example, the event management system 170 may identify that Users C, D, and E all attended Event 1. The event management system 170 may then automatically create an edge 203 between the user nodes 201 corresponding to these users in the graph structure 200.

### Similarity Scores

In particular embodiments, the event management system 170 may determine a similarity score for a pair of user nodes 201 in a graph structure 200. A first user node 201 may be given a similarity score with respect to one or more second user nodes 201. The first user node 201 may be connected by one or more edges 203 to a particular second user node 201. A similarity score of a first user node 201 with respect to a second user node 201 may represent the weight, value, rating, importance, or significance of the similarity of the first and second users corresponding to those respective nodes. User nodes 201 that are more similar (i.e., with a higher similarity score) are more likely to correspond to users that are interested in and/or attended the same events or types of events. A higher score may represent a stronger or more significant similarity between the users. As an example and not by way of limitation, a similarity score may be scored on a scale of 0 to 1.0, wherein a score of 0 represent no similarity and a score of 1.0 represents a maximum similarity. Although this disclosure describes using a particular scale for determining similarity scores, this disclosure contemplates using any suitable scale for determining similarity scores. Various factors may be used when determining a similarity score for a particular pair of nodes.

In particular embodiments, the event management system 170 may determine a similarity score for a first user node with respect to a second user node based on the event history information associated with the first and second user nodes. In particular embodiments, the event management system 170 may determine a similarity score between a first and second user based on the number of event attended concurrently by the first and second users. The event management system 170 may give higher similarity scores to users that attend more events concurrently. As an example and not by way of limitation, if a first user and a second user concurrently attended a rock concert, the event management system 170 may increase their similarity score by +0.2. As another example and not by way of limitation, if the first and second users concurrently attended two rock concerts, the event management system 170 may increase their similarity score by +0.3. In particular embodiments, the event management system 170 may calculate a similarity score between a first and second user based on the type of events attended concurrently by the first and second users. The event management system 170 may give higher similarity scores to users that concurrently attend particular types of events. As an example and not by way of limitation, attending a concert concurrently may increase a similarity score by +0.2 while attending a festival concurrently may increase a similarity score by +0.5. As another example and not by way of limitation, concurrently attending an event that costs $10 may change a similarly score less than concurrently attending an event that costs $200. In particular embodiments, the event management system 170 may determine a similarity score between a first and second user based on the number or type of events attended by the first and second users, either concurrently or non-concurrently. The event management system 170 may give higher similarity scores to users that attend more of the same or similar types of events. As an example and not by way of limitation, if the first user attends a music festival on one day and the second user attends the same music festival on another day, the event management system may increase their similarity score by +0.2. However, if the second user only attends a similar, but not the same, musical festival, then the event management system may only increase their similarity score by +0.1. As another example and not by way of limitation, if a first user attends a musical in one year and the second user attends the same musical festival the next year, the event management system may increase their similarity score by +0.1. In particular embodiments, the event management system 170 may calculate a similarity score between a first and second user based on the geographic location of the events attended by the first and second users. The event management system 170 may give higher similarity scores to users that frequently visit the same venue, location, or place, either concurrently or separately. As an example and not by way of limitation, if a first user attends a concert at Golden Gate Park and a second user later attends an art exhibit at Golden Gate Park, the event management system 170 may increase their similarity score by +0.1 based on their attendance of events at the same venue/location. Although this disclosure describes determining similarity scores based on particular event history information, this disclosure contemplates determining similarity scores based on any suitable event history information.

In particular embodiments, the event management system 170 may determine a similarity score for a first user node with respect to a second user node based on the number of categories associated with each user node that match. In particular embodiments, an event profile may be associated with one or more event categories. As an example and not by way of limitation, a particular event may be a food event, an alcohol/wine/beer event, an adult event, a children's event, a music event, a fine arts/crafts events, a visual arts events, a performing arts event, a sporting event, an endurance event, a technology event, an academic event, a networking event, a conference, a social event, a business event, a fundraising event, another suitable type of event, or any combination thereof. Event categories and event categorization are discussed more in U.S. patent application Ser. No. 13/278,902, filed 21 Oct. 2011, which is incorporated herein by reference. In particular embodiments, a user node 201 may be associated with one or more preferred event categories. These event categories are the types of events that the user 101 corresponding to the user node 201 has attended, is interested in, or likes to attend, and may be referred to as a user 101's “taste vector.” A user 101 may indicate that certain types of events are preferred (e.g., by manually providing preferred event types to event management system 170). Additionally, the event management system 170 may determine the event categories that should be associated with the user 101 based on the user 101's tastes, event history information, social networking information, other suitable information, or any combination thereof. The event management system 170 may determine the event categories to be associated with a particular user 101 in an analogous manner to how event categories are determined automatically for event profiles, as described in U.S. patent application Ser. No. 13/278,902. In particular embodiments, the event management system 170 may calculate a similarity score between a first and second user based on the number of preferred event categories that match between the first and second users. Users that have preferred event categories in common, or taste vectors that are similar, are more likely to be interested in the same events or types of events. As an example and not by way of limitation, if a first user and a second user both like food events (i.e., their user nodes are both associated with the food events category), the event management system 170 may increase their similarity score by +0.2. As another example and not by way of limitation, if the first user and the second user both like food event and music events, the event management system 170 may increase their similarity score by +0.3. As yet another example and not by way of limitation, if the first user has a taste vector indicating the user prefers fundraisers, conferences, and tech events, and a second user has a taste vector indicating the user prefers fundraisers, conferences, and music events, the event management system 170 may increase their similarity score by +0.25. In particular embodiments, the event management system 170 may calculate a similarity score between a first and second user based on the type of preferred event categories that match between the first and second users. The event management system 170 may give higher similarity scores to users that match particular types of event categories. As an example and not by way of limitation, if the first and second users both prefer networking events, their similarity score may increase by +0.1, but if the first and second users both prefer sporting events, their similarity score may increase by +0.2. Although this disclosure describes determining similarity scores based on particular event categories in a particular manner, this disclosure contemplates determining similarity scores based any suitable event categories in any suitable manner.

In particular embodiments, the event management system 170 may determine a similarity score for a first user node with respect to a second user node based on the social-network information associated with the first and second nodes. In particular embodiments, the event management system 170 may determine a similarity score between a first and second user based on the degrees of separation between the first and second users on a social graph. As an example and not by way of limitation, users that are first-degree friends may have a higher similarity score than users that are second-degree friends. In particular embodiments, the event management system 170 may determine a similarity score between a first and second user based on the geographic locations of the first and second users. As an example and not by way of limitation, if the first user and second user both list “Sebastopol, Calif.” as their hometown, the event management system 170 may increase their similarity score by +0.1 based on their listing the same hometown. In particular embodiments, the event management system 170 may determine a similarity score between a first and second user based on the interests of the first and second users. As an example and not by way of limitation, if a first user and a second user both list “Dungeons & Dragons” as an interest on their social network profiles, the event management system 170 may increase their similarity score by +0.2 based on their shared interest. In particular embodiments, the event management system 170 may determine a similarity score between a first and second user based on the demographic interests of the first and second users. Users with similar demographic information may be more likely to be interested in the same events or types of events. As an example and not by way of limitation, two users who are both college-educated white women may have a higher similarly score than users with differing educations, ethnicities, and sexes. Although this disclosure describes determining similarity scores based on particular social-network information in a particular manner, this disclosure contemplates determining similarity scores based any suitable social-network information in any suitable manner.

In particular embodiments, the event management system 170 may determine a similarity score for a first user node with respect to a second user node based on the number of user nodes 201 in the graph structure 200 that are connected to both the first and second nodes. Users with more connections in common may be more likely to have shared tastes, and therefore may have a higher similarity score. As an example and not by way of limitation, if User B and User H are both connected to User A, then the event management system 170 may increase the similarity scores of Users B and H by +0.1. As another example and not by way of limitation, if User B and User H are both connected to Users A, C, and I, then the event management system may increase the similarity scores of Users B and H by +0.2. In particular embodiments, the event management system 170 may determine a similarity score between a first and second user based on their similarity scores with a third user. As an example and not by way of limitation, if a first user and a second user both have high similarity scores with a third user, the event management system 170 may increase the similarity score between first and second users based on their high similarity scores with the third user. Although this disclosure describes determining similarity scores based on the number of shared connections in a particular manner, this disclosure contemplates determining similarity scores based on the number of shared connections in any suitable manner.

In particular embodiments, the event management system 170 may determine a similarity score for a first user node with respect to a second user node based on the degree of separation between the first and second user nodes in a graph structure 200. User nodes that are more directly connected on a graph structure may be more likely to have shared tastes, and therefore may have a higher similarity score. As an example and not by way of limitation, if two user nodes 201 are separated by two edges 203, the event management system 170 may increase their similarity score by +0.3 based on their second-degree connection in the graph structure 200. As another example and not by way of limitation, if two user nodes 201 are separated by three edges 203, the event management system 170 may increase their similarity score by +0.1 based on their third-degree connection in the graph structure 200. Although this disclosure describes determining similarity scores based on the degree of separation between users in a particular manner, this disclosure contemplates determining similarity scores based on the degree of separation between users in any suitable manner.

In particular embodiments, an event management system 170 may calculate a similarity score for a pair of user nodes using particular algorithms or models. The algorithms and models may be based on a variety of factors, such as, for example, the degree of separation between the users, social-network information of the users, the event history information of the users (e.g., the number of events the user has attended, the friends and connections the user has attended these events with), the number of preferred event categories the users have in common, other suitable information, or any combination thereof. The following is an example algorithm that the event management system 170 may use to calculate a similarity score for a pair of user nodes:

s_{1,2}=f(D_{1,2},E_{1,2},N_{1,2},C_{1,2})

where:
s_{1,2} is the similarity score for a first user with respect to a second user,
D_{1,2} is the degrees of separation between the first and second users,
E_{1,2} is the number of events the first and second users have attended in common,
N_{1,2} is the number of nodes in the graph structure that are connected to both the first and second users, and
C_{1,2} is the number of categories associated with first and second users that match.

The following is another example algorithm that the event management system 170 may use to calculate a similarity score for a pair of user nodes:

$${s}_{x , y} = \sqrt{{\sum }_{i = 1}^{N} \frac{{{w}_{i} ( {x}_{i} - {y}_{i} )}^{2}}{{σ}_{i}^{2}} + {\sum }_{j = 1}^{N} \frac{{{w}_{j ⋂ j} ( \frac{{x}_{j} ⋂ {y}_{j}}{{x}_{j}} - \frac{{x}_{j} ⋂ {y}_{j}}{{y}_{j}} )}^{2}}{{σ}_{j ⋂ j}^{2}}}$$

where:
s_{x,y} is the similarity score for a user x with respect to a user y,

$${\sum }_{i = 1}^{N} \frac{{{w}_{i} ( {x}_{i} - {y}_{i} )}^{2}}{{σ}_{i}^{2}}$$

is the partial similarity score for user x with respect to user y for each user's individual features i, for i from 1→N,
wᵢ is the weight of factor i,
xᵢ is the value of factor i for user x,
yᵢ is the value of factor i for user y,
σᵢ is the standard deviation of factor i across all users,

$${\sum }_{j = 1}^{N} \frac{{{w}_{j ⋂ j} ( \frac{{x}_{j} ⋂ {y}_{j}}{{x}_{j}} - \frac{{x}_{j} ⋂ {y}_{j}}{{y}_{j}} )}^{2}}{{σ}_{j ⋂ j}^{2}}$$

is the partial similarity score for user x with respect to user y for the user's shared features j, for j from 1→N,
w_{j∩j} is the weight of the common factor j,
xᵢ is the value of factor j for user x,
yᵢ is the value of factor j for user y, and
σ_{j∩j} is the standard deviation of factor common factor j across all users.

Although this disclosure describes calculating a similarity score for a pair of user nodes using a particular algorithm, this disclosure contemplates calculating a similarity score for a pair of user nodes using any suitable algorithm or model. Moreover, although this disclosure describes calculating a similarity score for a pair of user nodes using particular variables that represent particular information, this disclosure contemplates calculating a similarity score for a pair of user nodes using any suitable variables representing any suitable information.

### Event Recommendations Based on Similarity Scores

In particular embodiments, an event management system 170 may recommend particular events to a first user based on the first user's interests or taste, and further based on the events that the first user's friends and connections are registered to attend. A user is more likely to be interested in an event that his friends and connections with similarly interests and tastes are interested in. The event management system 170 may evaluate the first user's friends and connections to identify one or more second users with similar interests or tastes to the first user (i.e., users that have a relatively high similarity score with respect to the first user). The event management system 170 may then identify the events that those second users are interested in (e.g., events they are registered to attend, events that have been recommended to them by others) and recommend those events to the first user. Although this disclosure describes recommending events to a user in a particular manner, this disclosure contemplates recommending events to a user in any suitable manner.

In particular embodiments, an event management system 170 may access a graph structure 200 comprising a plurality of user nodes 201 and a plurality of edges 203 connecting the user nodes 201. The plurality of nodes may include a first user node corresponding to a first user. The first user node may be associated with one or more first event categories. These first event categories may be types of events that the first user has attended, is interested in, or likes to attend, and may also be referred to as the first user's preferred event categories or, collectively, as the first user's taste vector. The plurality of nodes may also include a plurality of second user nodes corresponding to a plurality of second users, respectively. Each second user node may be associated with one or more second event categories. Similarly, these second event categories may be types of events that a second user has attended, is interested in, or likes to attend. Each second user node may be associated with different event categories. As an example and not by way of limitation, one second user node may be associated with the event category of “food events,” while another second user node may be associated with the event category of “music events.” Each edge 203 between two nodes represents a single degree of separation between the two nodes. Each second user node may be separated from the first user node by one or more degrees of separation. In particular embodiments, each of the second user nodes may be within a threshold degree of separation from the first user node. As an example and not by way of limitation, each second user node may be within one, two, three, or all degrees of separation of the first user node. In particular embodiments, the event management system 170 may access only a portion of the graph structure 200. The event management system 170 may, for example, filter the graph structure 200 to access only user nodes 201 with particular preferred event categories or taste vectors, or to filter the graph structure 200 to access only user nodes 201 with preferred event categories or taste vectors that match those of the first user node. Thus, users may be segmented into particular sub-graphs of the parent graph structure (e.g., graph structure 200) that may be used for different applications. This may be beneficial for particular applications that utilize the event management system 170, such as, for example, third-party advertisers who want to advertise to a particular sub-group of users. This may also be beneficial from an efficiency standpoint by focusing analysis on a sub-set of users that have been pre-selected or pre-identified as being relevant. As an example and not by way of limitation, the event management system 170 may access a sub-graph of graph structure 200 comprising only user nodes 201 that are associated with the event category “music events.” As another example and not by way of limitation, the event management system 170 may access a sub-graph of graph structure 200 comprising only user nodes 201 that are associated with a taste vector indicating the user prefers “food events” and “sports events.” Although this disclosure describes accessing a particular graph structure in a particular manner, this disclosure contemplates accessing any suitable graph structure in any suitable manner.

In particular embodiments, the event management system 170 may determine, for each second user node of the plurality of second user nodes, a similarity score of the second user node with respect to the first user node. In other words, the event management system 170 may determine how similar each second user node is to the first user node. The event management system 170 may determine similarity scores as described previously. As an example and not by way of limitation, as illustrated in FIG. 2B, if the first user node is User B, then the event management system 170 may determine similarity scores for one or more of other user nodes illustrated in FIG. 2B with respect to User B. In particular embodiments, the event management system 170 may only calculate similarity scores for user nodes within a threshold degree of separation of the first user node. As an example and not by way of limitation, continuing with the prior example, if the threshold degree of separation is one then the event management may only calculated a similarity score for the user nodes corresponding to User B's first-degree connections and friends, who are Users A, C, I, J, and K in the example graph structure 200 illustrated in FIG. 2B. Although this disclosure describes determining a similarity score for a user node in a particular manner, this disclosure contemplates determining a similarity score for a user node in any suitable manner.

In particular embodiments, the event management system 170 may rank each of the second user nodes based on the respective similarity score. User nodes with higher similarity scores may be ranked higher than user nodes with lower similarity scores. As an example and not by way of limitation, continuing with the example in the prior paragraph, if the event management system 170 ranks the user nodes corresponding to Users A, C, I, J, and K with respect to the user node for User B, the event management system 170 may rank them: User I, User C, User A, User J, and User K, where User I has the highest similarity score and User K has the lowest similarity score. In particular embodiments, the event management system 170 may score each second user node based on the similarity score of the second user node to the first user node and then order the second user nodes based on the scoring. Although this disclosure describes ranking user nodes in a particular manner, this disclosure contemplates ranking user nodes in any suitable manner.

In particular embodiments, the event management system 170 may select a set of second user nodes based on the ranking of each second user node. User nodes with higher rankings may be selected over user nodes with lower rankings In particular embodiments, only user nodes with a ranking over a threshold ranking may be selected. As an example and not by way of limitation, continuing with the example in the prior paragraph, if the event management system 170 selects only the top two user nodes, it may select the user nodes corresponding to Users I and C, which have the two highest rankings Although this disclosure describes selecting user nodes in a particular manner, this disclosure contemplates selecting user nodes in any suitable manner.

In particular embodiments, the event management system 170 may identify one or more first events associated with the selected set of second user nodes. The first events associated with the second user nodes may be any suitable events. In particular embodiments, the first events may be pending events that one or more of the second users corresponding to the selected set of second user nodes is registered to attend. As an example and not by way of limitation, if User B is the first user node and User C is one of the selected second user nodes, and if User C is registered to attend Event 2, the event management system 170 may identify Event 2 as being an event associated with User C and may recommend Event 2 to User B. In particular embodiments, the first events may be pending events that have been recommended to one or more of the second users corresponding to the selected set of second user nodes. As an example and not by way of limitation, if User G recommends Event 3 to User K, the event management system 170 may create an edge 203 connecting the user nodes 201 corresponding to Users G and K. When event management system 170 is identifying events to recommend to User B, because User B and User K are connected by a “friend” connection in the graph structure 200, the event management system 170 may identify events that have been recommended to User K, such as Event 3, and recommend those events to User B. In this way, the event management system 170 may propagate event recommendations to a particular user to that user's friends and connections. In particular embodiments, events recommendations propagated in this manner may be propagated only to friends with a relatively high similarity score with respect to the user who first received the event recommendation. Although this disclosure describes identifying particular events in a particular manner, this disclosure contemplates identifying any suitable events in any suitable manner.

In particular embodiments, the event management system 170 may generate one or more advertisements for the first user comprising information corresponding to the one or more first events. Each event may be advertised individually. Alternatively, a particular advertisement may be generated for multiple events. The event management system 170 may generate any suitable advertisement for the first user. As an example and not by way of limitation, the advertisement may be included in a webpage, text, graphic image, email, instant message, text message, audio message, page, MMS text, social network message, another suitable format, or any combination thereof. The advertisement may contain details about the event, a link to the event profile, information about one or more of the second users who are associated with the event (e.g., friends or connections who are already registered to attend the event, or who have been recommended the event), other suitable information, or any combination thereof. As an example and not by way of limitation, if Event 2 has been identified for User B, then the event management system 170 may generate a webpage that includes an advertisement for Event 2 and display that webpage to User B. The webpage may contain a link to the event profile for Event 2, where User B may register for the event. The advertisement may as reference one or more of the second users that are already registered to attend the event. Event recommendations and event advertisements are discussed more in U.S. patent application Ser. No. 12/955,739, filed 29 Nov. 2010, which is incorporated herein by reference. Although this disclosure describes generating particular advertisements in a particular manner, this disclosure contemplates generating any suitable advertisements in any suitable manner.

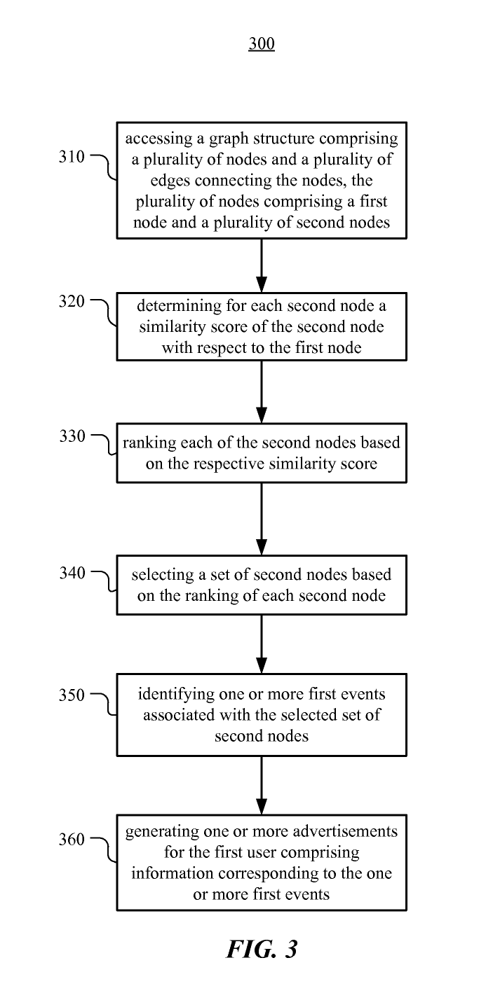

FIG. 3 illustrates an example method 300 for recommending events based on user similarity. The method may begin at step 310, where an event management system 170 may access a graph structure comprising a plurality of nodes and a plurality of edges connecting the nodes, each edge between two nodes representing a single degree of separation between the two nodes. The plurality of nodes may include a first node corresponding to a first user and that user may be associated with one or more first event categories. The plurality of nodes may also include a plurality of second nodes corresponding to a plurality of second users respectively. Each of the second nodes may be associated with one or more second event categories. Furthermore, each of the second nodes may be separated from the first node by one or more degrees of separation. At step 320, the event management system 170 may determine, for each second node of the plurality of second nodes, a similarity score of the second node with respect to the first node. At step 330, the event management system 170 may rank each of the second nodes based on the respective similarity score. At step 340, the event management system 170 may select a set of second nodes based on the ranking of each second node. At step 350, the event management system 170 may identify one or more first events associated with the selected set of second nodes. At step 360, the event management system 170 may generate one or more advertisements for the first user comprising information corresponding to the one or more first events. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

### Systems and Methods

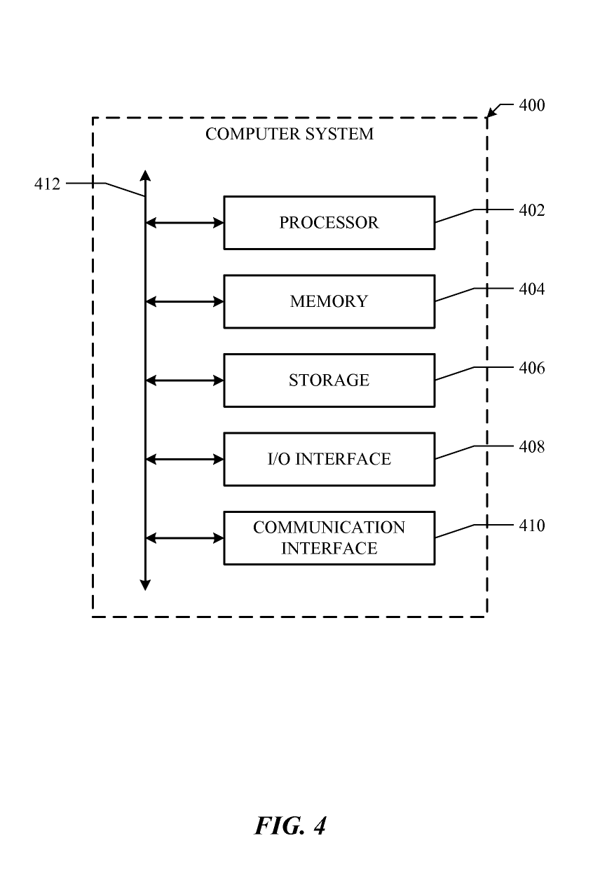

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, reference to a computer-readable non-transitory storage medium may include a semiconductor-based or other integrated circuit (IC) (such as, for example, a field-programmable gate array (FPGA) or an application-specific IC (ASIC)), a hard disk drive (HDD), a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, another suitable computer-readable non-transitory storage medium, or a suitable combination of these, where appropriate. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 402 (such as, for example, one or more internal registers or caches), one or more portions of memory 404, one or more portions of storage 406, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

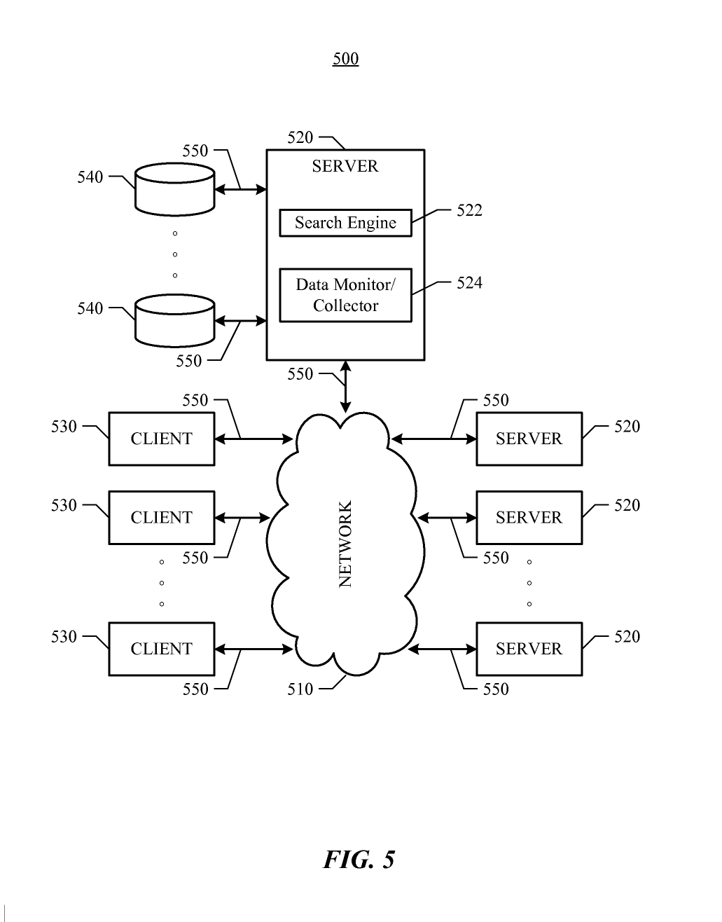

FIG. 5 illustrates an example network environment 500. This disclosure contemplates any suitable network environment 500. As an example and not by way of limitation, although this disclosure describes and illustrates a network environment 500 that implements a client-server model, this disclosure contemplates one or more portions of a network environment 500 being peer-to-peer, where appropriate. Particular embodiments may operate in whole or in part in one or more network environments 500. In particular embodiments, one or more elements of network environment 500 provide functionality described or illustrated herein. Particular embodiments include one or more portions of network environment 500. Network environment 500 includes a network 510 coupling one or more servers 520 and one or more clients 530 to each other. This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 510 may include one or more networks 510.

Links 550 couple servers 520 and clients 530 to network 510 or to each other. This disclosure contemplates any suitable links 550. As an example and not by way of limitation, one or more links 550 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 550. In particular embodiments, one or more links 550 each includes an intranet, an extranet, a VPN, a LAN, a WLAN, a WAN, a MAN, a communications network, a satellite network, a portion of the Internet, or another link 550 or a combination of two or more such links 550. Links 550 need not necessarily be the same throughout network environment 500. One or more first links 550 may differ in one or more respects from one or more second links 550.

This disclosure contemplates any suitable servers 520. As an example and not by way of limitation, one or more servers 520 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, a server 520 includes hardware, software, or both for providing the functionality of server 520. As an example and not by way of limitation, a server 520 that operates as a web server may be capable of hosting websites containing web pages or elements of web pages and include appropriate hardware, software, or both for doing so. In particular embodiments, a web server may host HTML or other suitable files or dynamically create or constitute files for web pages on request. In response to a Hyper Text Transfer Protocol (HTTP) or other request from a client 530, the web server may communicate one or more such files to client 530. As another example, a server 520 that operates as a mail server may be capable of providing e-mail services to one or more clients 530. As another example, a server 520 that operates as a database server may be capable of providing an interface for interacting with one or more data stores (such as, for example, data stores 540 described below). Where appropriate, a server 520 may include one or more servers 520; be unitary or distributed; span multiple locations; span multiple machines; span multiple datacenters; or reside in a cloud, which may include one or more cloud components in one or more networks.

In particular embodiments, one or more links 550 may couple a server 520 to one or more data stores 540. A data store 540 may store any suitable information, and the contents of a data store 540 may be organized in any suitable manner. As an example and not by way or limitation, the contents of a data store 540 may be stored as a dimensional, flat, hierarchical, network, object-oriented, relational, XML, or other suitable database or a combination or two or more of these. A data store 540 (or a server 520 coupled to it) may include a database-management system or other hardware or software for managing the contents of data store 540. The database-management system may perform read and write operations, delete or erase data, perform data deduplication, query or search the contents of data store 540, or provide other access to data store 540.

In particular embodiments, one or more servers 520 may each include one or more search engines 522. A search engine 522 may include hardware, software, or both for providing the functionality of search engine 522. As an example and not by way of limitation, a search engine 522 may implement one or more search algorithms to identify network resources in response to search queries received at search engine 522, one or more ranking algorithms to rank identified network resources, or one or more summarization algorithms to summarize identified network resources. In particular embodiments, a ranking algorithm implemented by a search engine 522 may use a machine-learned ranking formula, which the ranking algorithm may obtain automatically from a set of training data constructed from pairs of search queries and selected Uniform Resource Locators (URLs), where appropriate.

In particular embodiments, one or more servers 520 may each include one or more data monitors/collectors 524. A data monitor/collection 524 may include hardware, software, or both for providing the functionality of data collector/collector 524. As an example and not by way of limitation, a data monitor/collector 524 at a server 520 may monitor and collect network-traffic data at server 520 and store the network-traffic data in one or more data stores 540. In particular embodiments, server 520 or another device may extract pairs of search queries and selected URLs from the network-traffic data, where appropriate.

This disclosure contemplates any suitable clients 530. A client 530 may enable a user at client 530 to access or otherwise communicate with network 510, servers 520, or other clients 530. As an example and not by way of limitation, a client 530 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 530 may be an electronic device including hardware, software, or both for providing the functionality of client 530. As an example and not by way of limitation, a client 530 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, a client 530 may include one or more clients 530; be unitary or distributed; span multiple locations; span multiple machines; span multiple datacenters; or reside in a cloud, which may include one or more cloud components in one or more networks.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Furthermore, “a”, “an,” or “the” is intended to mean “one or more,” unless expressly indicated otherwise or indicated otherwise by context. Therefore, herein, “an A” or “the A” means “one or more A,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, this disclosure encompasses any suitable combination of one or more features from any example embodiment with one or more features of any other example embodiment herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
accessing, using one or more processors associated with one or more computing devices, a graph structure comprising a plurality of nodes and a plurality of edges connecting the nodes, each edge between two nodes representing a single degree of separation between the two nodes, the plurality of nodes comprising:
a first node corresponding to a first user, the first node being associated with one or more first event categories; and
a plurality of second nodes corresponding to a plurality of second users, respectively, each second node being associated with one or more second event categories, each second node being separated from the first node by one or more degrees of separation;
determining, using the one or more processors, for each second node of the plurality of second nodes, a similarity score of the second node with respect to the first node;
ranking, using the one or more processors, each of the second nodes based on the respective similarity score;
selecting, using the one or more processors, a set of second nodes based on the ranking of each second node; and
identifying, using the one or more processors, one or more first events associated with the selected set of second nodes.

2. The method of claim 1, further comprising:
generating, using the one or more processors, one or more advertisements for the first user comprising information corresponding to the one or more first events.

3. The method of claim 1, wherein determining the similarity score of a second node comprises:
determining a degree of separation between the second node and the first node; and
determining the similarity score of the second node with respect to the first node based on the degree of separation.

4. The method of claim 1, wherein determining the similarity score of a second node comprises:
determining a number of events the second user associated with the second node has attended in common with the first user;
determining the similarity score of the second node with respect to the first node based on the number of events.

5. The method of claim 1, wherein determining the similarity score of a second node comprises:
determining a number of nodes in the graph structure that are connected to both the second node and the first node;
determining the similarity score of the second node with respect to the first node based on the number of nodes.

6. The method of claim 1, wherein determining the similarity score of a second node comprises:
determining how many of the second event categories associated with the second node match the first event categories; and
determining the similarity score of the second node with respect to the first node based on the number of matching event categories.

7. The method of claim 1, wherein ranking each of the second nodes based on the respective similarity score comprises:
scoring each second node based on the similarity score of the second node to the first node; and
ordering the second nodes based on the scoring.

8. The method of claim 1, wherein the first events are pending events that one or more of the second users corresponding to the selected set of second nodes are registered to attend.

9. The method of claim 1, wherein the first events are pending events that have been recommended to one or more of the second users corresponding to the selected set of second nodes.

10. The method of claim 1, wherein the graph structure is based at least in part on a third-party social graph.

11. The method of claim 1, wherein the graph structure is based at least in part on the event history associated with each node, wherein an edge connecting two nodes indicates that the users associated with each of the two nodes attended the same event.

12. The method of claim 1, wherein each of the second nodes is within a threshold degree of separation from the first node.

13. The method of claim 1, wherein each of the second nodes is associated with at least one event category that matches one of the first event categories.

14. The method of claim 1, wherein the graph structure is a sub-graph of parent graph structure, the sub-graph comprising only nodes associated with pre-selected event categories.

15. The method of claim 1, wherein:
the first event categories are based on the event categories of one or more events the first user has attended; and
for each second node, the second event categories are based on the event categories of one or more events the second user has attended.

16. An apparatus comprising: one or more processors; and a memory coupled to the processors comprising instructions executable by the processors, the processors operable when executing the instructions to:
access a graph structure comprising a plurality of nodes and a plurality of edges connecting the nodes, each edge between two nodes representing a single degree of separation between the two nodes, the plurality of nodes comprising:
a first node corresponding to a first user, the first node being associated with one or more first event categories; and
a plurality of second nodes corresponding to a plurality of second users, respectively, each second node being associated with one or more second event categories, each second node being separated from the first node by one or more degrees of separation;
determine for each second node of the plurality of second nodes, a similarity score of the second node with respect to the first node;
rank each of the second nodes based on the respective similarity score;
select a set of second nodes based on the ranking of each second node; and
identify one or more first events associated with the selected set of second nodes.

17. One or more computer-readable non-transitory storage media embodying software that is operable when executed to:
access a graph structure comprising a plurality of nodes and a plurality of edges connecting the nodes, each edge between two nodes representing a single degree of separation between the two nodes, the plurality of nodes comprising:
a first node corresponding to a first user, the first node being associated with one or more first event categories; and
a plurality of second nodes corresponding to a plurality of second users, respectively, each second node being associated with one or more second event categories, each second node being separated from the first node by one or more degrees of separation;
determine for each second node of the plurality of second nodes, a similarity score of the second node with respect to the first node;
rank each of the second nodes based on the respective similarity score;
select a set of second nodes based on the ranking of each second node; and
identify one or more first events associated with the selected set of second nodes.
